(19) United States
(12) Patent Application Publication
(10) Pub. No.: US 2006/0143675 A1
(43) Pub. Date: Jun. 29, 2006

(54) Proxy advertisement server and method

(76) Inventors: Daniel Willis, Stittsville (CA); Dhananjay Godse, Kanata (CA); Gordon Freedman, Ottawa (CA)

Correspondence Address: FREEDMAN & ASSOCIATES, 117 CENTREPOINTE DRIVE, SUITE 350, NEPEAN, ONTARIO, K2G 5X3, CA

(21) Appl. No.: 11/303,971

(22) Filed: Dec. 19, 2005

Related U.S. Application Data
(60) Provisional application No. 60/636,546, filed on Dec. 17, 2004.

(51) Int. Cl. G06F 13/00; H04N 7/173; G06F 3/00; H04N 7/16; H04N 5/445

(52) U.S. Cl. 725/114; 725/42; 725/144

(57) ABSTRACT

A system and method for supporting the storage of advertising data used for providing advertisements in video games relies upon a proxy server for storing the advertising data. Specifically, in a video game device that supports a network communications and does not support a large non-volatile memory suitable for storing advertising data a storage media external to the video game device is identified and a portion of the storage media is reserved for storing advertising data. During a video game session an opportunity to provide an advertisement is detected and suitable advertising data is identified on the storage medium and transferred to the computing device via the network.

### REFERENCE TO PRIOR APPLICATION

This application claims benefit from United States Provisional Application No. 60/636,546 filed on Dec. 17, 2004, the entire contents of which is incorporated herein by reference.

### FIELD OF THE INVENTION

The invention relates to providing dynamic content in video games. More specifically, the invention relates to storing dynamic content within devices intermediate to a dynamic content server and a video game processing device.

### BACKGROUND OF THE INVENTION

In order to mitigate the cost of producing increasingly sophisticated video game consoles, often video game consoles are designed with very advanced processing features but little extraneous or general-purpose hardware. One hardware device that is not common to all video game consoles is fast, efficient, large-scale perpetual read-write storage. Some game consoles such as the XBOX® include a hard disk drive for providing fast perpetual storage for saving games, for storing game related data, and for storing of programming information. Other game consoles such as the PlayStation II are absent a hard disk drive.

It is becoming desirable to support dynamic delivery of advertising content within video games. Dynamic advertising content allows an advertiser to compensate the producer of a video game for the privilege of promoting a product or service within the game when played. Dynamic advertisements are designed to be downloaded from a server via a wide area network, such as the Internet, and displayed during a video game session.

Unfortunately there are technical challenges associated with delivering dynamic advertising to video games during execution thereof. First, video game performance should not be impacted by advertising data delivery—a player should not wait for a scene to be rendered because advertising data is being received. Second, video game visuals should be adversely unaffected by the advertising content—it should appear complete and as if it belongs within the scene. Third, advertising content should not consume necessary processing or memory resources within the gaming system.

When a personal computer supports a video game session featuring dynamic advertising, a video game when executed requests advertising data from a server via the Internet. The advertising data is transmitted from the server via available bandwidth when the personal computer network port and processor are sufficiently available to receive the advertising data. Since the gamer does not wish to wait for advertising data to arrive, any advertising data received is stored on a hard disk drive until the game execution has a need for the advertising data. In this way, at some future time when a video game session is executed a same advertising data remains available. As such, the personal computer resources allow for preloading of advertising data to allow for high performance game execution without concern for bandwidth, advertising data size, or gaming system limitations. While personal computers are often used to play video games, it is more common to play video games using a video game console. As is well known in the art, consoles represent an inexpensive and consistent platform to support video games. Unfortunately, as noted above, many console systems do not support hard disc drives and, as a result, are not as well suited for providing dynamic advertising according to the above identified method.

As gaming with Internet enabled consoles becomes more popular there is increasing demand for providing a dynamic advertising solution that works with a console system that does not have a large non-volatile random access read-write memory. One option is to provide or sell a large non-volatile random access memory for use with the game consoles. This solution is flawed because of the additional cost of providing a flash memory card or a hard disk drive with the game to support advertising is unlikely to be acceptable to consumers and therefore would result in video game console sales generating a significant loss for their manufacturer. Unless there is a very large return on this loss, the resulting business model is unlikely to be acceptable. It would be advantageous to provide a method for supporting delivery of dynamic advertising content to video games in execution on Internet connected consoles that other than have large non-volatile random access memory storage.

### SUMMARY OF THE INVENTION

In accordance with the invention there is provided a method of providing a proxy server comprising: executing on a computing device video game software having an opportunity to provide dynamic content; establishing a first data communications link between the computing device and a first server; providing a proxy server accessible to and remote from the computing device; establishing a second data communications link between a content server and the proxy server; transferring electronic data from the content server to the proxy server; establishing a third data communication link between the proxy server and the computing device; transferring the electronic data from the proxy server to the computing device; and, providing dynamic content in the video game in dependence upon the electronic data.

In accordance with another aspect of the invention there is provided a system comprising: a first server for providing dynamic content; a first computing device for executing a video game; and, a first proxy server for retrieving of content from the first server and for, at a later time, providing the content to the first computing device for use within the video game.

In accordance with another aspect of the invention there is provided a storage medium having data stored therein, the instruction data for when executed resulting in the steps of: receiving a request for dynamic content from a video game in execution on a computing device at a remote location; providing a proxy server accessible to and remote from the computing device; establishing a second data communications link between a content server and the proxy server; and, transferring electronic data from the content server to the proxy server, the content provided to the proxy server fro use in responding to the request for dynamic content, requested dynamic content provided from the proxy server.

### BRIEF DESCRIPTION OF THE DRAWINGS

The invention is now described with reference to the drawings in which:

FIG. 1 is a schematic diagram of a computing device that communicates with an advertising server via an Internet service provider and a public network;

FIG. 2 is a simplified network diagram supporting dynamic in game advertising in which a proxy server is provided on a public network;

FIG. 3 is a simplified network diagram supporting dynamic in game advertising in which a proxy server is provided by an Internet service provider;

FIG. 4 is a simplified network diagram supporting dynamic in game advertising in which a proxy server is disposed on a network local to a computing device; and,

FIG. 5 is a simplified network diagram supporting dynamic in game advertising in which a plurality of computing devices send and receive advertising data.

### DETAILED DESCRIPTION OF EMBODIMENTS OF THE INVENTION

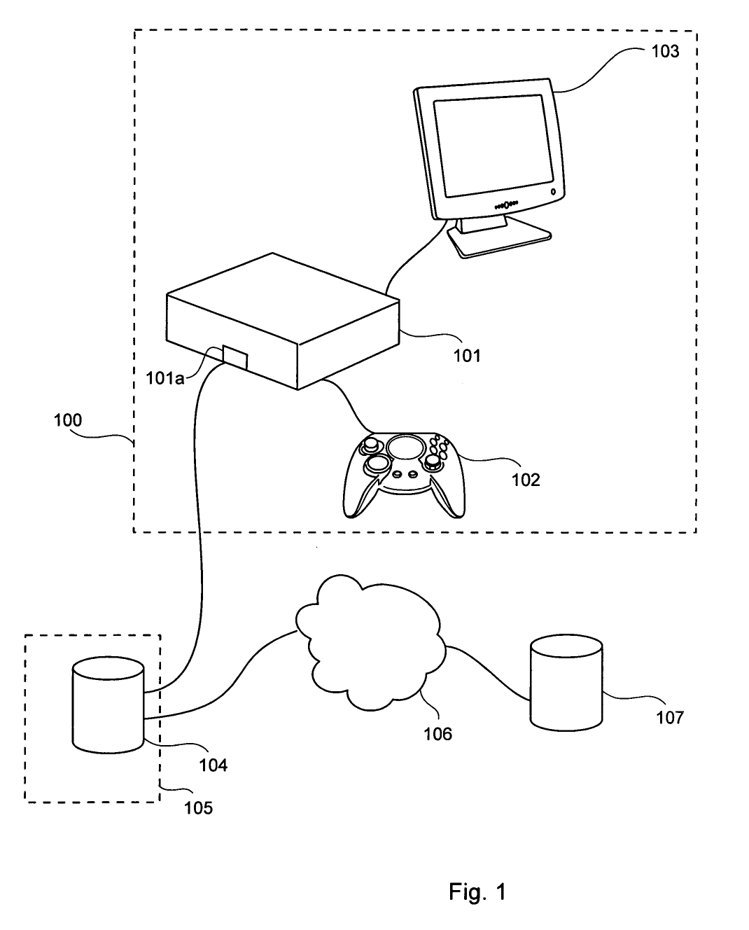

Referring to FIG. 1, a video game system 100 is shown. The video game system 100 comprises: a computing device in the form of a game console 101, a controller 102 for receiving user input signals, and a video display 103 in the form of a television. The game console 101 comprises a communication port 101a for establishing data communication with other devices via a network. The communication port 101a is shown in communication with a server 104 of an Internet service provider (ISP) 105. The server 104 of the ISP 105 is in data communication with a wide area network (WAN) 106 supporting broadband communication, in the form of a public network such as the Internet. An advertising server 107 stores advertising data and is in data communication with the WAN 106. Optionally, the advertising server 107 is provided by an advertising service provider (ADSP.) In use, the game console transmits a request for advertising data, the request propagates to the advertising server 107 via the ISP 105 and the WAN 106. The advertising server 107 locates appropriate advertising data and provides it to the game console 101 via the WAN 106 and the ISP 105.

In use, the game console 101 executes instructions for resulting in a gaming session supporting advertising spots within the game. The advertising spots are suitable for impressing advertising content provided independent from the media in which the game software is provided. Herein, the game software is optionally referred to as an advertising enabled game. In order to provide advertising content dynamically, the advertising content is provided to the advertising enabled game via WAN 106.

Downloading of advertising data from an advertising server via a public network both is time consuming and occurs in a non-guaranteed and non-predictable fashion. Both the routing of data within the public network and the response time of the server and of other servers disposed between the game console and the advertising server is other than consistent. Thus, it is expected that when the game requests advertising data at a time immediately preceding a time when the advertisement is provided on the screen 103 then the appropriate advertising data is often unavailable to provide the advertising impression. Therefore, it is desirable to pre-store the advertising data within the game console for instant retrieval when needed. This is typically performed near video game start-up. When the game console 101 has access to a local hard disc drive then it is a simple matter to store the advertising data locally on the hard disc or a fast flash random access memory for present and future use. Unfortunately, without a large memory store and without changing video game designs, this is difficult absent a large persistent store.

According to the present invention, advertising data is pre-stored within the network accessible to the game console but more proximate the game console than the advertising server for retrieval therefrom such that downloads of the advertising data are more readily accessible, more reliably accessible and more predictable. This reduces demand on the advertising server 107 and increases reliability of advertising data delivery timing.

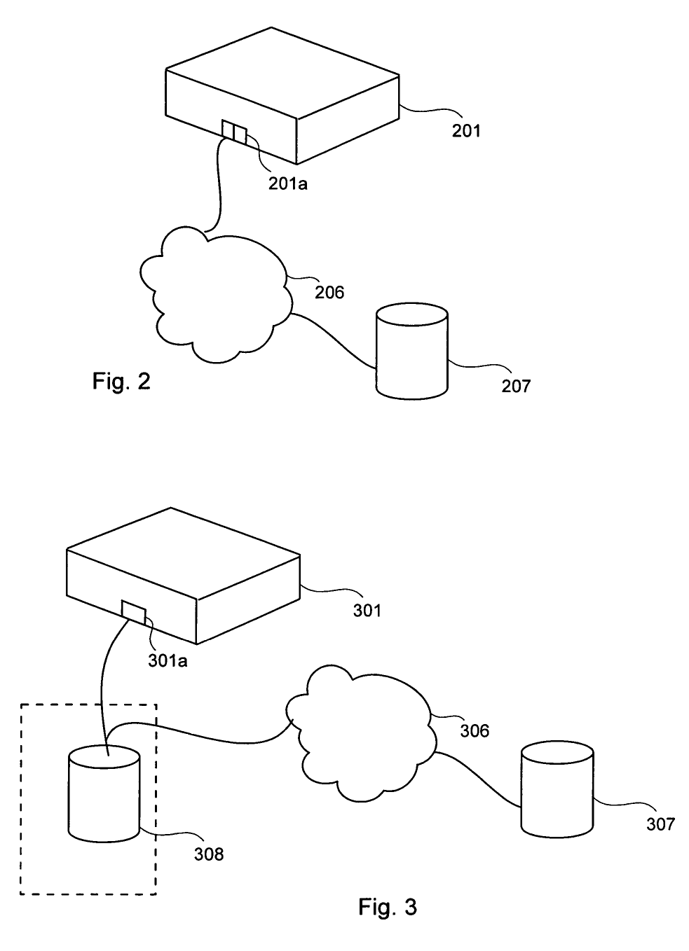

Referring to FIG. 2 a video game system is shown in which a computing device 201 supports a video game session. The computing device 201 comprises a communication port 201a. Additionally, an advertising server 207 and a public network 206, such as the Internet, are also shown.

In use, a gamer initiates a video game session on the computing device 201. The computing device 201 determines that there are advertising spots available. The computing device 201 then queries the advertising server 207 for advertising data. Since, the computing device 201 does not feature an available and sufficiently large non-volatile memory for storing advertising data, a proxy server is requested. Within the proxy server is allocated electronic memory for storing of advertising data. Thus, when the computing device requests advertising data associated with twenty advertisements, the data associated with the twenty advertisements is retrieved by the proxy server from the advertising server. Clearly, the copying of data to the proxy server occurs independent of the hardware of the computing device 201. Thus, data is optionally transferred to the proxy server when the computing device 201 is not in operation. Further, the proxy server optionally supports much higher bandwidth than the computing device 201 and, as such, copying of the advertising data often occurs quite rapidly. Here, the proxy server comprises a data storage device. The choice of the location of the proxy server is at least partially dependent upon bandwidth characteristics between the proxy server and the computing device 201 and available proxy servers. Preferably, the proxy server is disposed with as little intervening network infrastructure between the proxy server and the computing device 201 to ensure network communication performance therebetween. Alternatively, the proxy server is disposed with some level of guaranteed service between the proxy server and the computing device 201. This helps support efficient data transfer from the proxy server to the computing device 201. Additionally, since the data is available from the proxy server, downloading the advertising data to the computing device with a just in time (JIT) approach is supported. Alternatively, the advertising content is downloaded a little earlier in case of delays. Since the computing device 201 has all of the advertising data provided by the proxy server the downloading of the data is very much more efficient regardless of a location of the computing device 201.

For example, when a distributed server provider is the proxy server, the computing device 201 optionally determines an approximate data transfer rate for data transferred from the proxy server to the computing device 201. When the game executes, it communicates to the proxy server the advertising data it requires. The proxy server then awaits a further indication from the game that a particular advertising datum is required. This further indication is provided before the advertising datum is actually used by the game by an amount of time dependent upon the determined data transfer rate and an amount of data within the advertising datum. By adding some additional time it is possible to ensure complete advertising data delivery on time in a large majority of situations.

The above embodiment of the invention serves to mitigate the problems of providing dynamic advertising content to a computing device. In some cases it is insufficient to provide a high quality gaming experience due to bandwidth constraints between the computing device 201 and the proxy server. Thus, optionally an instruction is executed to determine a relative time for downloading the advertising data. If this relative length of time is above a known threshold then the computing device makes a request for the same data in a-format with higher compression. Alternatively, instead of compressing the advertising data, a request is made for alternative advertising textures that occupies less memory and therefore consumes less time to download. Further alternatively, both lower quality and higher compression are used together to result in even lower bandwidth requirements.

Referring to FIG. 3 a video game system is shown in which a computing device 301 supports a video game session. The computing device 301 comprises a communication port 301a. Additionally, an Internet service provider (ISP) with a server 308, an advertising server 307 and a public network 306, such as the Internet, are also shown. In use, the computing device 301 supports a video game session. The video game software supports dynamic advertising and the computing device 301 in execution of the video game software makes a request for advertisement data from the advertising server 307. The video game software requests a Proxy server to store advertising content in its non-volatile storage resources. Here, the proxy server selected is a server within the domain of Internet service provider (ISP) for the computing device 301. The ISP provides a proxy server on server 308. When the proxy server is in operation, the advertising server 307 provides advertising data to the proxy server. The video game software communicates with the proxy server to retrieve advertising data content therefrom. Requests for advertising data are routed to the proxy server, which in turn retrieves the advertising data from the advertising server 307. The proxy server then provides the advertising data to the computing device 301 when requested. Since the proxy server is provided in the domain of the ISP, the advertising data is stored in such a manner that it is accessible to the computing device 301 without transferring data via the public network. This improves a reliability of the data transfer allowing the gaming software to accurately schedule advertising data requests and to thereby improve resource utilisation efficiency based on game software execution requirements and available bandwidth. The ISP has a direct path to the computing device and within the ISP, is determinable a priority for the proxy computing device 301 communication path. Further, the use of the ISP server allows for storage of the data within special allocations of the gamer that are already being paid for in the gamer's monthly subscription charges. Thus, additional costs to the advertising service provider are optionally mitigated.

Optionally, when insufficient resources are available to support transfer of advertising data to the computing device 301, a request is provided for the advertising data in a compressed form. Alternatively, the advertising data is requested for a lower resolution advertisement, thereby occupying less memory.

Since the ISP is coupled with the network through a high bandwidth connection, the ISP has access to the advertising content data with less delay and optionally comprises independent advertising management software for maintaining updated advertising content even when the video game is other than being played. Thus, game performance and proxy server performance are maintained with little impact to the ISP or the computing device 301.

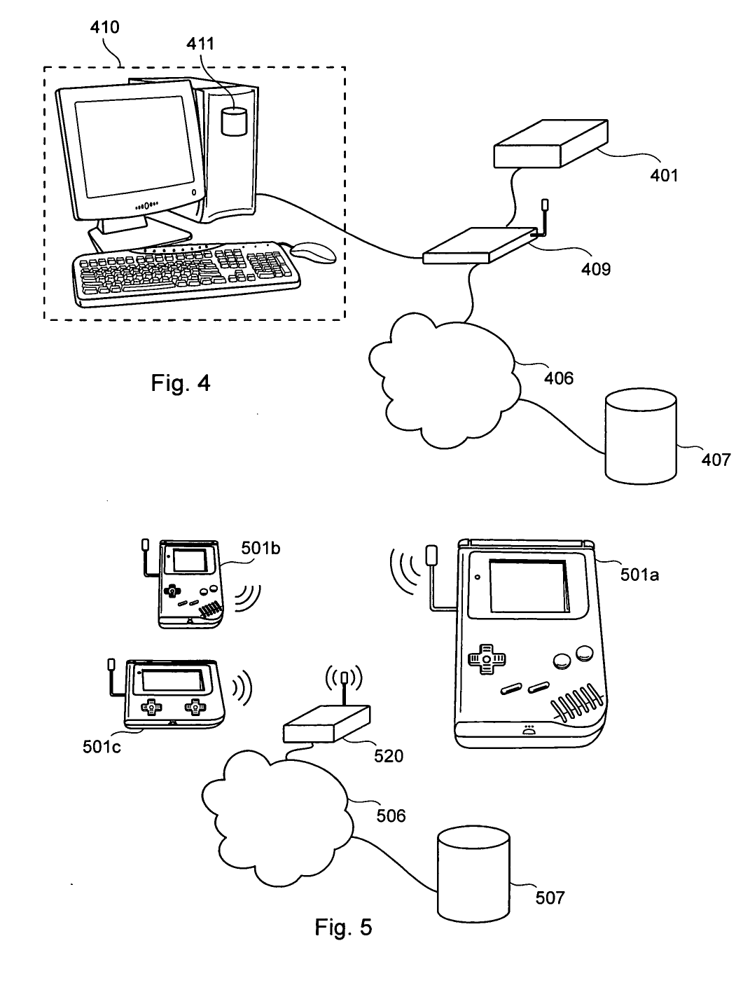

Referring to FIG. 4, a video game system is shown in which a computing device 401 supports a video game session. The computing device 401 comprises a communication port 401a. The communication port 401a is shown coupled with a router 409. The router is further coupled to a personal computer 410 that comprises a hard disc drive 411. Additionally, an advertising server 407 and a WAN 406, in the form of a public network such as the Internet, are also shown. The router 409 supports a local network that allows various electronic devices coupled with the router 409 to share information and contact the public network 406.

In use, a gaming session is initiated on the computing device 401. The gaming session supports dynamic advertising. The video game software in execution within the computing device 401 requests dynamic advertisements from the advertising server 407 via the router 409 and the public network 406. Due to insufficient memory resources of the computing device 401, a proxy server is used. In FIG. 4, the proxy server comprises the personal computer 410, which allocates space within the hard disc drive for proxying of advertising data. The advertising server then provides advertising data to the proxy server on the hard disc drive where it is stored. Once the advertising data is available from the hard disc drive, requests for advertising data provided from the computing device are responded to by the proxy server. Of course, a local computer coupled to the computing device 401 via a local area network (LAN) provides relatively high bandwidth and, also of significant importance, insulation from network or server performance issues. The network and server performance are easily monitored by a gamer operating the computing device 401. Optionally, advertising data is downloaded to the proxy server, personal computer 410, when the computing device 401 is not in use.

Sometimes the personal computer 410 is not available while the computing device 401 is used. Often it is beneficial to combine the teachings of two or more proxy server embodiments. Thus, when the hard disc drive of the personal computer 410 is other than available advertising data is provided from a secondary proxy server that is optionally disposed within at least one of the ISP and the public network 406.

A network connection common to many video game console devices supports very high bandwidth relative to the bandwidth normally associated with home Internet connection. Further, the computing device optionally supports a separate network connection for coupling with a WAN and a network connection to connect the computing device to other computing devices.

Referring to FIG. 5, a first computing device 501 comprises a wireless link. The wireless link allows the first computing device 501a to communicate with second and third computing devices 501b and 501c respectively. The wireless link additionally supports communication between the first computing device and a wireless data transceiver 520. The wireless data transceiver 520 permits the first computing device 501a to communicate with an advertising server 507 via a wide area network (WAN) in the form of a public network 506 such as the Internet. In use, the first computing device supports a video game session suitable for providing dynamic advertisements. The first computing device 501a sends a message to the advertising server 507 requesting advertising data identifiers. The advertising server 507 provides the advertising data identifiers to the first computing device 501a. The first computing device 501a scans a memory of the first computing device 501a for advertising data corresponding to the advertising data identifiers. When the first computing device 501a does not have all of the advertising data corresponding to the advertising data identifiers the first computing device 501a sends a request to other computing devices 501b and 501c for the remaining advertising data via the wireless link. The second and third computing devices 501b and 501c provide advertising data corresponding to the remaining advertising data. In the event that advertising data corresponding to one or more of the advertising data identifiers is other than available from the memories of the first, second and third computing devices 501, 501b and 501c then the first computing device 501a acts to obtain the desired advertising data via the public network 506. This embodiment of the invention provides increasing storage capacity for advertising data as the number of computing devices that communicate via the wireless link increases. A person of skill in the art will appreciate that there are a variety of protocols available to transfer data from one wireless computing device to another. For example, a cellular telephone supports data transfer using a cellular network however, laptops support 802.11 compatible wireless protocol and blue tooth data connections. Clearly, such a laptop optionally obtains advertising data using any of the wireless capabilities available to it. A person of skill in the art will appreciate that it is beneficial to use a low cost data transfer option that has sufficient bandwidth.

Though the above embodiments refer to a proxy server for supporting a single video game processor, optionally, a single proxy supports multiple video games and/or multiple video game processors. For example, when a server of an ISP acts as a proxy server, it optionally supports several video game processors simultaneously or concurrently. For example, when a first video game—GAME A—is initiated on a video game processor, it contacts an ad server and then tries to establish a proxy. The server on the ISP, already being set up to act as proxy, replies and the proxy server connection is formed. Since the server is already serving ads to GAME A, when a further ISP subscriber initiates GAME A on their video game processor, the ISP serves GAME A with a same proxy server. This limits bandwidth, storage and processor resources consumed in ad serving. For larger ISPs, optionally more than a single proxy is maintained to support a larger on-line enabled game community.

Of course, the proxy server for supporting multiple video game processors provides a level of efficiency. Its advertising content is typically more up to date as it is frequently updated.

Alternatively, the proxy updates ad content on its own during off-peak bandwidth hours. These are typically times when video game sessions are not being started in mass. For example, from 4 AM to 6 AM bandwidth consumption is often quite low. The proxy optionally updates all advertising content during this time period in order to reduce overhead for supporting in game advertising.

Alternatively, a plurality of computing devices communicates via an ad hoc wireless network. Using the ad hoc network, a computing device is able to obtain dynamic content from other computing devices within the ad hoc network that have garnered advertising content from outside the functional wireless range of the computing device.

Various embodiments of the invention make specific reference to a hard disc drive as a suitable non-volatile storage medium for supporting a proxy server that stores advertising data. A person of skill in the art will appreciate that a variety of other forms of non-volatile storage media, such as flash memory devices, are also suitable.

A person of skill in the art will appreciate that the invention is well suited to a variety of devices that support data communication and video games. For example, a cellular telephone that does not have a large non-volatile memory is suitable for use with various embodiments of the invention. Similarly, personal digital assistants (also referred to as PDAs) are similarly suitable. A person of skill in the art will appreciate that an advertising site would comprise at least an advertising server for storing and providing advertising data. Further optionally, a data communications connection between a computing device used to support a video game session and an advertising site is optionally established using a broker. Thus, one of skill in the art would likely refer to a game console supporting a gaming environment having advertising spots therein, in communication with an advertising server over an Internet connection, in which the data connection is supported by an advertising broker as a “broker mediated advertising gaming environment.”

Further, for large advertising assets comprising several advertisements—ads to be shown in succession, the use of a proxy allows the ad campaigns to be divided into separately delivered content to reduce overhead for the video game processor.

A use of compression is sometimes advantageous. In order to be advantageous, a processing cost of decompression is less than a cost of transferring and storing the data in uncompressed form. When compression is used, storage requirements on a proxy server or on the local system are reduced allowing for storage of more advertising content. Conversely, when advertising content is decompressed by the video game processor, availability is highly predictable. Thus storage of advertising content within a local cache in a compressed format for decompression nearer its use is advantageous for maintaining more advertising data in a smaller store. Advantageously, this also reduces a cost associated with storing advertising content for video games that are other than being played. Further advantageously, this reduces bandwidth for transmitting and receiving of the advertising content.

Optionally, advertising content is compressed and or expanded within the network. This occurs at the ad server, at the ad broker, at the proxy server, and/or at the video game processor. Further, different compression methods are useful for different stages of the communication path when desired.

In another embodiment of advertising content management, the advertising content is stored in compressed form and when a video game is initiated, the advertising content for that video game when current is decompressed. This gives rise to two significant advantages. Decompression occurs in an order for ensuring decompression of advertising content before it is needed within the video game and storage requirements for advertising content other than presently in use are reduced. Of course, network bandwidth is also saved when content is transmitted in a compressed form. Though this adds a level of complexity in managing a store of advertising content some of which compressed and some of which is not, it also adds a level of flexibility. For example, a video game processor analyses network delays and requests all advertising data in compressed form to save on data delivery time. Alternatively, when a proxy is local to a video game processor network, advertising content is requested decompressed to off load de-compression from the video game processor.

Numerous other embodiments of the invention will be apparent to one of skill in the art without departing from the spirit and the scope of the invention.

What is claimed is:

1. A method of providing a proxy server comprising:
executing on a computing device video game software having an opportunity to provide dynamic content;
establishing a first data communications link between the computing device and a first server;
providing a proxy server accessible to and remote from the computing device;
establishing a second data communications link between a content server and the proxy server;
transferring electronic data from the content server to the proxy server;
establishing a third data communication link between the proxy server and the computing device;
transferring the electronic data from the proxy server to the computing device; and,
providing dynamic content in the video game in dependence upon the electronic data.

2. A method according to claim 1, wherein the content server comprises the first server.

3. A method according to claim 1, wherein the first server comprises a broker server and the content server comprises an advertising server for serving of dynamic advertising content and wherein the opportunity comprises at least an advertising spot.

4. A method according to claim 3, wherein providing dynamic content comprises impressing advertising content upon a gamer of the video game.

5. A method according to claim 4, wherein the advertising content comprises streaming media advertising content.

6. A method according to claim 1, wherein the proxy server is independent of the computing device.

7. A method according to claim 1, comprising:
determining that a non-volatile memory of the computing device is insufficient for storing a copy of the dynamic content; and
requesting memory accessible to and independent of the computing device.

8. A method according to claim 1, wherein the electronic data comprises advertising data.

9. A method according to claim 8, wherein the computing device communicates with the first server via a broadband public network and the proxy server is disposed on a non-volatile memory of a server of the broadband public network.

10. A method according to claim 8, wherein the computing device communicates with the first server via a broadband public network and the computing device communicates with the broadband public network via an Internet service provider and the proxy server is disposed on a non-volatile memory of the Internet service provider.

11. A method according to claim 8, wherein the computing device communicates with the first server via a local area network and the computing device and the proxy server is disposed on a non-volatile memory of another computing device in data communication with the local area network.

12. A method according to claim 8, comprising:
providing an available bandwidth from and available storage capacity of a non-volatile memory of a server of a broadband public network in communication with the computing device and the first server;
providing an available bandwidth from and available storage capacity of a non-volatile memory of a server of an Internet service provider in data communication with the broadband public network;
providing an available bandwidth from and available storage capacity of a non-volatile memory of a second computing device in data communication with the computing device via a local area network; and,
providing a proxy server in at least one of the memory of a server of a broadband public network, the memory of a server of an Internet service provider and, memory of the second computing device.

13. A method according to claim 12, wherein the proxy server stores advertising data having a relative level of detail, the relative level of detail of the advertising data chosen in dependence upon bandwidth and available storage capacity of the memory supporting the proxy server.

14. A method according to claim 8, comprising:
determining an available bandwidth from and available storage capacity of a non-volatile memory of a server of a broadband public network in communication with the computing device and the first server;
determining an available bandwidth from and available storage capacity of a non-volatile memory of a server of an Internet service provider in data communication with the broadband public network;
determining an available bandwidth from and available storage capacity of a non-volatile memory of a second computing device in data communication with the computing device via a local area network; and,
providing a proxy server in at least one of the memory of a server of a broadband public network, the memory of a server of an Internet service provider and, memory of the second computing device.

15. A method according to claim 2, wherein the proxy server provides proxy server services to a plurality of video games in concurrent execution, each video game accessing dynamic content from a same memory store, some of the plurality of video games receiving identical content from an identical memory location within the same memory store.

16. A method according to claim 15, wherein the proxy server comprises a process for updating of the dynamic content proxied thereby automatically, the process requesting updated dynamic content.

17. A method according to claim 3, wherein the proxy server provides proxy server services to a plurality of video games in concurrent execution, each video game accessing dynamic content from a same memory store, some of the plurality of video games receiving identical content from an identical memory location within the same memory store.

18. A method according to claim 17, wherein the proxy server comprises a process for updating of the dynamic content proxied thereby automatically, the process requesting updated dynamic content.

19. A method according to claim 1, comprising:
providing a second other proxy server accessible to and remote from the computing device;
establishing a second data communications link between a content server and the second other proxy server; and,
transferring electronic data from the content server to the second other proxy server;

20. A system comprising:
a first server for providing dynamic content;
a first computing device for executing a video game; and,
a first proxy server for retrieving of content from the first server and for, at a later time,
providing the content to the first computing device for use within the video game.

21. A system according to claim 20 wherein the content comprises advertising content and wherein use within the video game comprises impressing the advertising content upon a gamer of the video game in execution.

22. A storage medium having data stored therein, the instruction data for when executed resulting in the steps of:
receiving a request for dynamic content from a video game in execution on a computing device at a remote location;
providing a proxy server accessible to and remote from the computing device;
establishing a second data communications link between a content server and the proxy server; and,
transferring electronic data from the content server to the proxy server, the content provided to the proxy server fro use in responding to the request for dynamic content, requested dynamic content provided from the proxy server.
